(19) United States
(12) Patent Application Publication
(10) Pub. No.: US 2006/0111923 A1
(43) Pub. Date: May 25, 2006

(54) System and a method for selecting a property based on prioritized criteria of a purchaser

(76) Inventor: Douglas Elslager, Cincinnati, OH (US)

Correspondence Address: PATENTS+TMS, P.C., 2849 W. ARMITAGE AVE., CHICAGO, IL, 60647, US

(21) Appl. No.: 10/996,862

(22) Filed: Nov. 24, 2004

(51) Int. Cl. G06Q 99/00

(52) U.S. Cl. 705/1

(57) ABSTRACT

A method and a system for using a computer network to select a list of available properties based on prioritized criteria of a potential purchaser are provided. The method and the system use a computer network to evaluate and/or to weigh criteria prioritized by the purchaser. The computer network matches the resulting analysis with information about available properties in various communities. Based on the matching, the computer network provides a list of properties to an administrator or to the purchaser.

### BACKGROUND OF THE INVENTION

The present invention generally relates to a system and a method for selecting a property. More specifically, the present invention relates to a system and a method for selecting a list of properties available for purchase, such as, for example, island properties based on prioritized criteria of a purchaser. The system and method may weigh the prioritized criteria of the purchaser and may compare information relating to a plurality of properties stored in a database. Properties that may match the prioritized criteria of the purchaser may be selected and/or may be reviewed by an administrator of the system. The administrator may notify the purchaser of the selected properties. Alternatively, the system and the method may directly notify the purchaser of the properties that may match the prioritized criteria of the purchaser.

Purchasers of real estate often experience difficulty locating a property to purchase when the search for property is executed from a location remote to the area in which the property for purchase is desired. To find a property from among many properties available on, for instance, many islands, may cause the purchaser to incur tremendous expense in money and time. If the purchaser were required to visit all available properties on, for instance, many islands, the purchaser is required to spend large amounts of time traveling to the available properties, by air, water and land. The time spent traveling to the available properties may be detrimental to the progress and/or the ultimate goal of purchasing a property. Additionally, the money spent traveling to the available properties may be detrimental to the purchaser. If the purchaser visits a remote property, the purchaser may experience difficulty finding transportation to the remote property. These difficulties may be worsened by the purchaser's inability to communicate with residents in the area of the properties due to, for example, language barriers. As a result, the purchaser may incur time and monetary expenses.

Because of the distance between the purchaser and the desired property, the purchaser may never find the property due to, for example, lack of information. If inquiries by the purchaser about available properties are not directed to the proper individuals and/or business organizations, the inquiries may be ineffective. As a result, the purchaser may never learn of properties that are available. Of course, this problem may occur even if the purchaser does contact the proper individuals and/or business organizations, but does not speak the same language as they do.

When a purchaser searches for a property that is in a remote area, the purchaser may not be provided with the proper tools to identify properties that may be desirable. This difficulty may also be worsened if the individual and/or business organization assisting the purchaser does not carefully assess many attributes about the communities surrounding available properties. For example, the individual and/or business organization assisting the purchaser may understand the type of property desired by the purchaser, but not understand the type of community in which the purchaser desires to purchase a property. For instance, there are climate differences between islands that may be an important distinction to the purchaser. Also, there are differences in the safety of some islands relative to other islands. If the purchaser does not receive or otherwise obtain information about differing island climates and safety, the purchaser may be directed to properties that are not desirable. Of course, this problem may be worsened if the purchaser does not speak the same language as the individual and/or business organization that is assisting the purchaser.

When a purchaser searches for a property that is in a remote area, the purchaser may not be sufficiently guided through the process by the individual and/or business organization assisting the purchaser. Searching for a property on a variety of islands may be difficult due to the policies of and/or changes in local government associated with a particular island. As a result, the purchaser may be directed to properties that are not desirable and may incur time and monetary expenses if the purchaser otherwise had information related to the policies and/or the local government. Further, the purchaser who is not guided properly may fail to navigate the local requirements to complete a real estate transaction.

A common method for selecting a property for a purchaser generally involves contacting a real estate agent local to the area of the desired property. The local real estate agent asks the purchaser questions to ascertain the desires of the purchaser, requirements and/or priorities regarding the purchase of property. Accordingly, the local agent is often required to conduct a lengthy interview of the purchaser. The local real estate agent provides information regarding available properties that meet the desires, requirements and/or priorities of the purchaser. However, the local agent often only has knowledge of properties that are available on one island. Moreover, the local agent only possesses information relating to the real estate transactions on one island. Therefore, the purchaser receives only a limited number of property listings. Further, the local agent may not understand and/or comprehend the relative importance of the priorities of the purchaser. Therefore, the local agent may not suggest suitable properties to the purchaser. Also, the purchaser is required to use multiple agents if he/she is looking at property on more than one island and may incur time and monetary expenses. Alternatively, selecting property for a purchaser may involve the purchaser personally inspecting available property listings via, for example, a computer on a computer network, such as, for example, the internet. However, this may take excessive amounts of time and the purchaser may not have access to all pertinent property listings.

Moreover, individuals and/or business organizations, such as, realtors and/or property brokers may utilize computer networks to search for properties for the purchaser. Such computer searches may be executed from and may provide access to the databases contained within the computer network and/or via the internet. The computer programs may require input from the purchaser, such as, for example, a desired location, a price range and/or a number of desired bedrooms. It is, of course, generally known to provide databases having information thereon. The information may be stored within the databases for accessing the information at a later time. Further, it is generally known to provide access to databases on a computer network, such as, for example, the internet.

A need, therefore, exists for an improved system and a method for selecting a property listed in a database based on criteria that may be prioritized by the purchaser.

### SUMMARY OF THE INVENTION

The present invention generally relates to a system and a method for selecting a property based on criteria of a purchaser. More specifically, the present invention relates to a method and a system for using a computer network to evaluate and/or to weigh criteria prioritized by the purchaser. The system and the method may match the resulting analysis with available properties in various communities and/or may provide a list of selected properties to an administrator and/or a purchaser.

The system and the method may require the purchaser and the administrator to input data into a database via input devices. The purchaser may assign a level of importance and/or a weight factor to criteria describing a desired property and/or criteria describing desired community attributes (hereinafter “priority information”). The purchaser may update the priority information. The administrator may input information relating to available properties (hereinafter “property information”) and information relating to communities surrounding the available properties (hereinafter “community information”) into the database. The administrator may update the property information and community information. A computer program may compile the priority information, the property information, and/or the community information. The property information and/or the community information may then be matched to the priority information within the database, and a list of selected properties which may be available may be provided. The database may store the list of selected properties. The administrator may access the list of selected properties through an output device. Alternatively, the purchaser may access the list of selected properties through the output device.

To this end, in an embodiment of the present invention, a method for selecting a property based on prioritized criteria of a potential purchaser is provided. The method has the steps of: providing a computer network wherein the computer network has a database; storing property information in the database wherein the property information is based on attributes of the plurality of properties; storing community information in the database wherein the community information is based on attributes of a plurality of communities surrounding the plurality of properties; providing a first access to the database via the computer network wherein the purchaser inputs priority information into the database via the first access wherein the priority information is stored in the database wherein the priority information is based on priorities of the purchaser and further wherein the priorities relate to the property information and the community information; matching the property information and the community information to the priority information; assigning values to the property information based on the matching of the property information and the community information to the priority information; selecting the one or more properties based on the values assigned to the property information; and providing a list of the one or more properties to an administrator wherein the list contains the one or more properties selected based on the values assigned to the property information.

In an embodiment, the method has the step of storing the list in the database.

In an embodiment, the method has the step of providing a second access to the database via the computer network.

In an embodiment, the list of selected properties is provided to the purchaser.

In an embodiment, the first access is remote with respect to the database.

In an embodiment, the method has the step of providing a remote server and storing the database on the remote server.

In an embodiment, the method has the step of updating the property information, the community information, and the priority information in the database.

In an embodiment, the method has the step of displaying the list of selected properties via the computer network.

In an embodiment, the plurality of properties are located on at least one of a plurality of islands.

In another embodiment of the present invention, a system for selecting one or more properties from a plurality of properties for a purchaser is provided. The system has a computer network wherein the computer network has a database. Means is provided for inputting property information, community information and priority information into the database wherein the property information, the community information and the priority information are stored in the database, wherein the property information is based on attributes of the plurality of properties, wherein the community information is based on attributes of a plurality of communities surrounding the plurality of properties wherein the community information is represented by primary criteria, secondary criteria, and tertiary criteria, and further wherein the priority information is based on priorities of the purchaser with respect to the attributes of the property information and the community information. Further, means is provided for executing a computer program wherein the computer program processes the primary criteria, the secondary criteria and/or the tertiary criteria wherein the computer program ranks the property information and further wherein the computer program selects the one or more properties from the plurality of properties based on the ranking of the property information.

In an embodiment, a first access to the database is provided to obtain identification of the one or more properties.

In an embodiment, the first access is remote with respect to the database.

In an embodiment, the system includes a remote server wherein the database is stored on the remote server.

In an embodiment, the database is updated via the computer network.

In another embodiment of the present invention, a method for selecting one or more properties from a plurality of islands for a purchaser is provided. The method comprises the steps of: providing a computer network wherein the computer network has a database; providing property information wherein the property information is stored in the database and further wherein the property information is based on attributes of a plurality of properties on the plurality of islands; providing community information wherein the community information is stored in the database and further wherein the community information is based on attributes of a plurality of communities on the plurality of islands surrounding the plurality of properties; providing a first access to the database via the computer network wherein the purchaser inputs priority information into the database via the computer network wherein the priority information is stored in the database and further wherein the priority information is based on priorities of the purchaser with respect to the criteria of the property information and the community information; and selecting the one or more properties located on the plurality of islands based on the property information, the community information and/or the priority information.

In an embodiment, the method has the step of updating the property information, the community information, and the priority information in the database via the computer network.

In an embodiment, the one or more properties selected are provided in a list.

In an embodiment, the method has the step of providing a second access to the database to retrieve identification of the one or more properties selected.

In an embodiment, the purchaser is provided identification of the one or more properties selected.

In an embodiment, the database is stored on a remote server.

It is, therefore, an advantage of the present invention to provide a system and a method for selecting a property based on the desires, requirements and/or priorities of the purchaser.

It is, therefore, an advantage of the present invention to provide a system and a method for selecting a property based on prioritized criteria of a purchaser, reflecting the relative importance of the purchaser's desires, requirements and/or priorities.

Another advantage of the present invention is to provide a system and a method for selecting a property based on prioritized criteria of a purchaser which are stored in a database.

Yet another advantage of the present invention is to provide a system and a method for selecting a property which stores property information and community information, such as information about differing climates, governments and levels of safety, in a database.

And, another advantage of the present invention is to provide a system and a method for selecting a property which has a database that can be updated with new priority information, property information and community information.

Further, an advantage of the present invention is to provide a system and a method for selecting a property by matching the prioritized criteria of a purchaser to property information and community information.

Yet another advantage of the present invention is to provide a system and a method for selecting a property based on prioritized criteria of a purchaser which provides access to a database via a computer network.

A still further advantage of the present invention is to provide a system and a method for selecting a property based on prioritized criteria of a purchaser which eliminates the need for the purchaser to visit an excessive number of available properties.

Further, an advantage of the present invention is to provide a system and a method for selecting a property based on prioritized criteria of a purchaser which provides a comprehensive database of properties available through many places.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of the computer network having a computer network, interconnected input and output devices, information, and a database in an embodiment of the present invention.

FIG. 2 illustrates a black box diagram for the administrator to input property information and community information into a database in an embodiment of the present invention.

FIG. 3 illustrates a black box diagram for the purchaser to input priority information into a database in an embodiment of the present invention.

FIG. 4 illustrates a flowchart of steps for the administrator and purchaser to input information into the database and the computer network to match the information and/or to select a list of properties that are available in an embodiment of the present invention.

### DETAILED DESCRIPTION OF THE PRESENTLY PREFERRED EMBODIMENTS

The present invention generally relates to a system and a method for selecting a property based on criteria of a purchaser. More specifically, the present invention relates to a method and a system for using a computer network to evaluate and/or to weigh criteria prioritized by the purchaser. The system and the method may match the resulting analysis with available properties in various communities and/or may provide a list of selected properties to an administrator and/or a purchaser.

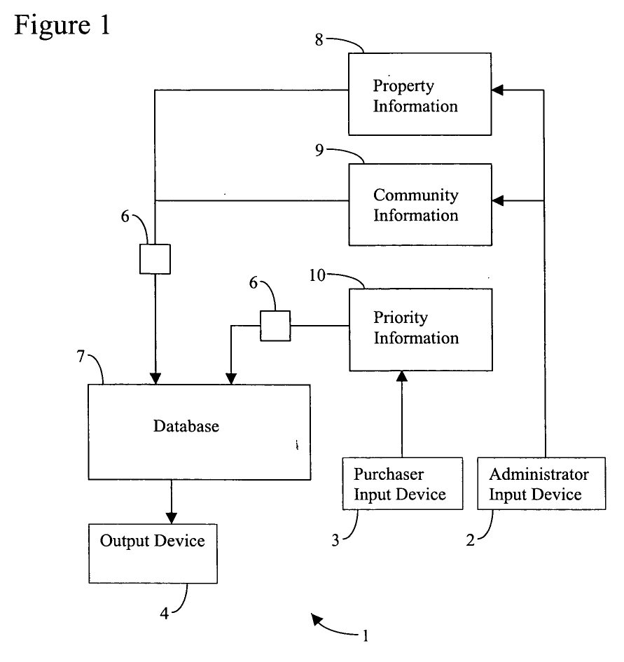

Referring now to the drawings wherein like numerals refer to like parts, FIG. 1 illustrates a computer network 1 which may have an administrator input device 2, a purchaser input device 3 and/or an output device 4. The computer network 1 may be any type of system of interconnected computers. Any computer network may be utilized that may be apparent to those skilled in the art. Of course, any number of computers may be connected to the computer network. The administrator input device 2, purchaser input device 3 and output device 4 may be a single computer together, or multiple computers.

The computer network 1 may include a database 7 which may be used to store information input by an administrator (not shown) through an administrator input device 2. Also, the database 7 may be used to store information input by a purchaser (not shown) through a purchaser input device 3. The administrator input device 2 may be used to input property information 8 and/or community information 9 into the database 7. The purchaser input device 3 may be used to input priority information 10 into the database 7. The database 7 may be located on a remote server. The administrator and/or the purchaser may use any of the computers 2, 3 and/or 4 to access the database 7 to input, update, and/or retrieve the property information 8, the community information 9 and/or the priority information 10.

The property information 8 may describe characteristics about a specific property. For example, characteristics about a specific property may include any one or more of the following: photographs, address, price, age, construction, taxes, school districts, types and quantities of rooms, room dimensions, lot dimensions, details about a garage and/or a basement, details about heating and/or cooling systems, details about plumbing and/or electrical systems, details about security and/or telecommunications systems, and/or details about appliances. The community information 9 may describe characteristics about a specific community, as are defined by secondary criteria 12 and tertiary criteria 13, to be described in further detail below.

The priority information 10 may describe the level of importance and/or weighting factor the purchaser assigns to part or all of the property information 8 and/or the community information 9. For example, the purchaser may assign a high weighting factor to the requirement for a cooling system, part of the property information 8, if that is important to the purchaser. Likewise, the purchaser may assign a low weighting factor to the regional crime occurrence, part of the community information 9, below, if that is unimportant to the purchaser.

A computer program 6 may compile the property information 8, the community information 9 and the priority information 10. The computer program 6 may compare and/or match the property information 8 and the community information 9 to the priority information 10. Then, the computer program 6 may assign a value to the property information 8 and may select a list of properties (not shown) based on the assigned values. The list of properties may be stored in the database 7 and may be retrieved from the database 7 via the output device 4.

The list of properties may be reviewed by the administrator, who may select one or more properties and may provide the one or more properties to the purchaser. Alternatively, the purchaser may review and/or may select one or more properties from the list of properties. Alternatively, the computer program 6 may select one or more properties from the list of properties and may provide the one or more properties to the administrator and/or the purchaser.

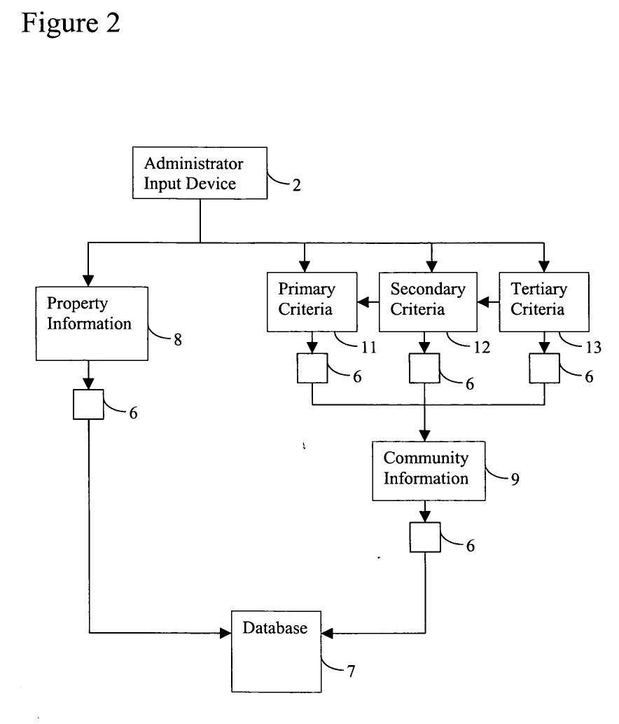

FIG. 2 illustrates the system and method for the administrator to input the property information 8 and the community information 9 into the database 7 via the administrator input device 2. The community information 9 may be represented by the primary criteria 11, the secondary criteria 12, and/or the tertiary criteria 13.

The primary criteria 11 may include any one or more of the following countries and/or islands: the Cayman Islands, the Virgin Islands, the Caribbean Islands, the Canary Islands, the French Polynesian Islands, the Greek Islands, the Mediterranean Sea Islands, the Hawaiian Islands, the South Pacific Islands, the Gulf Islands, the Canadian Islands, the Galapagos Islands, the European and Scandinavian Islands, the Indian Ocean Islands, the African Islands, the North American Islands, the Central American Islands, the South American Islands, and/or other known islands or groups of islands.

The secondary criteria 12 may describe a characteristic of a country and/or an island and may include any one or more of the following characteristics: accessibility of an island from the United States; the quantity and type of airports available for use; the requirements to establish local citizenship; yearly climate trends; the availability of communication technologies; crime types and rates; the cultures of indigenous peoples; customs and immigration policies; financial impacts of property ownership; the national and local forms of government; the probability of hurricane activity; the quantity and type of marinas; accessibility to and the quality of medical care; the ability to bring and care for pets; local population figures; real estate transaction laws and issues; the quality and type of recreational activities; the quality and type of restaurants; the quantity, quality and type of roads; safety; the availability of shipping services; the availability of shoreline property; the quality and type of shopping; local terrain and topography; and the quality and type of utilities.

The tertiary criteria 13 may further define the secondary criteria 12. The tertiary criteria 13 for the secondary criteria 12 representing the accessibility of an island from the United States may include one or more of the following: whether a local airport is available; whether direct flights from the United States to the island are available; for direct flights, details regarding departure cities and carriers providing direct flights; for indirect flights, details regarding connecting cities and local carriers providing connecting flights from locations outside the United States; the probable number of layovers associated with indirect flights; the estimated time of arrival at a given property after departure from the United States; whether a ferry is required to get to a given property; the availability of taxi and ground transportation at the final destination; and whether private autos are allowed.

The tertiary criteria 13 for the secondary criteria 12 representing the quantity and type of airports available for use may include one or more of the following: details regarding the length, width and weight capacities of runways; the presence of a control tower at each airport; the availability of private air and operations facilities for airplane repair and maintenance; the availability of hangers for airplane storage; the amount of landing fees; the availability of airport night operations; and the hours of airport operations.

The tertiary criteria 13 for the secondary criteria 12 representing the requirements to establish local citizenship may include one or more of the following: the process to become a citizen; the advantages and/or disadvantages of citizenship; and the availability of dual citizenship.

The tertiary criteria 13 for the secondary criteria 12 representing yearly climate trends may include one or more of the following: average regional air temperatures in the summer and winter; high and low regional air temperatures in the summer and winter; the average number of regional sunny days per year; the average regional rainfall quantities per year; average regional wind speeds and directions in the summer and winter; the monthly time periods of the dry and wet seasons; a rating to assess the regional risk of hurricane activity; and the number of hurricane “hits” in the last 15 years.

The tertiary criteria 13 for the secondary criteria 12 representing the availability of communication technologies may include one or more of the following: the availability and location of local computer facilities that may provide internet access and other services; technology available within the computer facilities; identification of local cellular telephone carriers; and the availability of land phone service in the region.

The tertiary criteria 13 for the secondary criteria 12 representing crime types and rates may include one or more of the following: a rating of occurrence of local crime activity; categorization of types of crime present in the region; the availability of home alarm systems; and the requirements and/or restrictions for gun ownership.

The tertiary criteria 13 for the secondary criteria 12 representing the cultures of indigenous peoples may include one or more of the following: a summary of the heritage of the indigenous people in the region; and the friendliness, honesty and reliability of the local citizens.

The tertiary criteria 13 for the secondary criteria 12 representing customs and immigration policies may include one or more of the following: whether a passport or alternate identification is required to travel to the destination; the percentage range of local duty charged on imports to the region; the maximum length of stay permitted; an overall rating of difficulty associated with complying with the customs and immigration policies; and the cost and duration for a boat cruising permit.

The tertiary criteria 13 for the secondary criteria 12 representing financial impacts of property ownership may include one or more of the following: the amount of and requirement to pay income taxes, property taxes, sales taxes, value added taxes, and asset taxes; the quantity of local banks; the requirements to open banking accounts; the availability of brokerages; the requirement to open brokerage accounts; the strength of the local currency; whether United States dollars are exchanged as currency; and the approximate local exchange rate to the United States dollar.

The tertiary criteria 13 for the secondary criteria 12 representing the national and local forms of government may include one or more of the following: whether the region is part of an independent country; whether the region is affiliated with another country; and the type of the national and local governments present.

The tertiary criteria 13 for the secondary criteria 12 representing the probability of hurricane activity may include: a rating of the hurricane threat, including the risk of hurricane reaching land and the severity of the hurricane upon land.

The tertiary criteria 13 for the secondary criteria 12 representing the quantity and type of marinas may include one or more of the following: the quantity of marinas in the region; the quantity of local slips available; the maximum overall vessel length allowed; controlling depth restrictions; the availability of 3-phase power; the availability of pump out; and the average cost per foot of slip.

The tertiary criteria 13 for the secondary criteria 12 representing accessibility to and the quality of medical care may include one or more of the following: the quantity of local medical facilities; the presence of a local hospital; whether med-jet transportation is used; whether vaccination are required; and whether vaccination are recommended.

The tertiary criteria 13 for the secondary criteria 12 representing the ability to bring and care for pets may include one or more of the following: whether pets can be brought to the region; the requirements before pets can be brought to the region; and the availability of veterinarian care.

The tertiary criteria 13 for the secondary criteria 12 representing local population figures may include the following: the approximate local population.

The tertiary criteria 13 for the secondary criteria 12 representing real estate transaction laws and issues may include one or more of the following: restrictions on transactions; closing costs as an approximate percentage of purchase price; whether there is receipt of the actual property title; and the availability of homecare professionals.

The tertiary criteria 13 for the secondary criteria 12 representing the quality and type of recreational activities may include one or more of the following: the quantities of local golf courses; a rating of average golf course conditions; the types of local fishing; a rating of average fishing conditions; the availability of charters; the availability of hiking; the availability of tennis; the availability of SCUBA facilities; the availability of spas; and a rating of spa conditions.

The tertiary criteria 13 for the secondary criteria 12 representing the quality and type of restaurants may include one or more of the following: the quantity of local restaurants; a rating of the general quality of local restaurants; the quantity of local gourmet restaurants; and a notation of the predominant local flavor.

The tertiary criteria 13 for the secondary criteria 12 representing the quantity, quality and type of roads may include one or more of the following: whether roads are mostly paved; an overall rating of road quality; the availability of interior land roads; and the availability of coastal roads.

The tertiary criteria 13 for the secondary criteria 12 representing safety may include one or more of the following: the quantity of police facilities; hours of police operations; the quantity of fire departments; hours of fire department operations; the effectiveness of emergency response personnel; the responsiveness of emergency response personnel; ratings of emergency response personnel effectiveness and responsiveness; a rating of the presence of pests; and whether deadly pests are present.

The tertiary criteria 13 for the secondary criteria 12 representing the availability of shipping services may include one or more of the following: the quantity of local ocean freight facilities that import and/or export to/from the region; the locations of the region's Ports of Entry; the locations of local customs clearing houses; the availability of UPS at the closest port of entry; the availability of FedEx at the closest port of entry; and the availability of mail service.

The tertiary criteria 13 for the secondary criteria 12 representing the availability of shoreline property may include one or more of the following: the availability of sandy beachfront property for sale; approximate percentages of beachfront coastline available; a rating of beachfront conditions; the availability of beachfront views; a rating of beachfront conditions and views; the availability of ironshore waterfront property for sale; approximate percentages of ironshore waterfront coastline available; a rating of ironshore conditions and views; the availability of hillside water view properties for sale; approximate percentages of water view coastline available; and a rating of water view conditions and views.

The tertiary criteria 13 for the secondary criteria 12 representing the quality and type of shopping may include one or more of the following: the availability of local grocery stores; a rating of overall grocery quality; a rating of overall grocery selection; the availability of fashionable clothing; the availability of jewelry and apparel; the availability of brand name items and luxury name items; the availability of hardware stores; and the availability of supplies.

The tertiary criteria 13 for the secondary criteria 12 representing local terrain and topography may include one or more of the following: an assessment of a region as mountainous, rolling or flat; the height of regional elevations; usual local vegetation; and a rating of local soil conditions.

The tertiary criteria 13 for the secondary criteria 12 representing the quality and type of utilities may include one or more of the following: the availability of electricity; a rating of reliability of electricity; the availability of natural gas; the availability of fuel sources; the availability of public water; a rating of reliability of public water; an assessment of whether public water is desirous and safe to drink without filtration; the availability of cable television; and the availability of garbage/trash pick-up.

The administrator may input the primary criteria 11 representing the property information 8 and the community information 9. Also, the administrator may input the secondary criteria 12 and/or the tertiary criteria 13 representing the community information 9. The computer program 6 may be implemented to compile the primary criteria 11, the secondary criteria 12 and/or the tertiary criteria 13 and may further store the results of the compilation in the database 7.

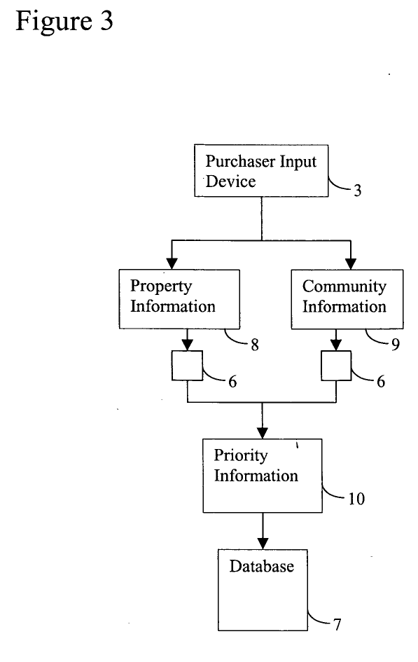

FIG. 3 illustrates the system and the method for the purchaser to input the priority information 10 into the database 7 via the purchaser input device 3. The purchaser may assign a level of importance and/or a weighting factor to part or all of the property information 8 and/or the community information 9. This priority information 10 may be stored in the database 7. The computer program 6 may be implemented to compile the priority information 10 and may further store the results of the compilation in the database 7.

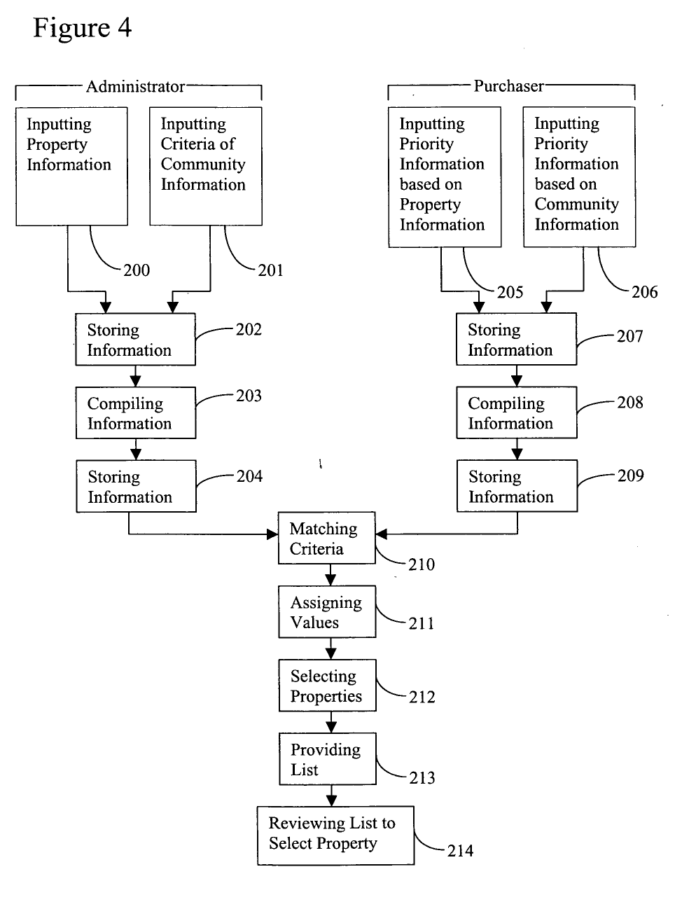

FIG. 4 illustrates a flowchart of a method for selecting a property. The administrator may input property information 8, via step 200. Also, the administrator may input the primary criteria 11, the secondary criteria 12 and/or the tertiary criteria 13 defining the community information 9, via step 201. The property information 8 and the community information 9 may be stored in the database 7 via step 202. The computer program 6 may be implemented to compile the property information 8 and the community information 9 via step 203 and may further store the results of the compilation via step 204.

The purchaser may input the priority information 10 based on assigning values to a part or all of the property information 8, via step 205. Also, the purchaser may input the priority information 10 based on assigning values to a part or all of the community information 9, via step 206. The priority information 10 may be stored in the database 7 via step 207. The computer program 6 may compile the priority information 10 via step 208 and may store the result via step 209.

The property information 8 and the community information 9 may be matched against the priority information 10 via step 210. A value may be assigned to each available property based on the matching via step 211. One or more available properties may be selected based on the assigned values of the properties via step 212. A list of the selected properties may be provided via step 213. The list may be reviewed by the administrator, the purchaser and/or the computer network 1 to select a property via step 214.

Together, FIGS. 1 through 4 illustrate the system and method for selecting a property on a remote island or in a country based on the requirements, desires and/or priorities of a purchaser. The system and method may rely on the administrator to build a comprehensive database 7 of available properties and/or the communities surrounding the properties. Then, the system and method may rely on the purchaser to provide information about the requirements, desires and/or priorities of the purchaser to the database 7. The computer program 6 may match the information provided by the administrator to the information provided by the purchaser. The result may be a list of properties that are available and/or conforming with the requirements, desires and/or priorities of the purchaser.

Thus, the system and method may allow the purchaser to visit a small number of suitable properties before making a decision about purchasing one property. Because the purchaser need only visit a small number of suitable properties, the system and method may save the purchaser time and monetary expense. Alternatively, the system and method may allow the purchaser to purchase a suitable property without visiting the property; saving the purchaser the time and monetary expense associated with any visit.

The system and method may provide flexibility to modify the property information 8, the community information 9 and the priority information 10. Further, the system and method may provide flexibility to modify the primary criteria 11, the secondary criteria 12, and the tertiary criteria 13. Moreover, properties may be input, updated and/or removed from the database 7 as the availability of those properties changes. Further, information about communities may be input, updated and/or removed as characteristics of those communities change. Still further, the priorities of the purchaser may be input, updated and/or removed as controlled by inputs of the purchaser. Each change to the property information 8, the community information 9, and/or the priority information 10 in the database 7 may result in changes to the list of properties that are selected after the matching process. Therefore, changes to the database 7 may provide the purchaser with a variety of suitable properties and may provide the purchaser with current and accurate properties.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A method for selecting one or more properties from a plurality of properties for a purchaser, the method comprising the steps of:
providing a computer network wherein the computer network has a database;
storing property information in the database wherein the property information is based on attributes of the plurality of properties;
storing community information in the database wherein the community information is based on attributes of a plurality of communities surrounding the plurality of properties;
providing a first access to the database via the computer network wherein the purchaser inputs priority information into the database via the first access wherein the priority information is stored in the database wherein the priority information is based on priorities of the purchaser and further wherein the priorities relate to the property information and the community information;
matching the property information and the community information to the priority information;
assigning values to the property information based on the matching of the property information and the community information to the priority information;
selecting the one or more properties based on the values assigned to the property information; and
providing a list of the one or more properties to an administrator wherein the list contains the one or more properties selected based on the values assigned to the property information.

2. The method of claim 1 further comprising the step of:
storing the list in the database.

3. The method of claim 1 further comprising the step of:
providing a second access to the database via the computer network.

4. The method of claim 1 wherein the list of selected properties is provided to the purchaser.

5. The method of claim 1 wherein the first access is remote with respect to the database.

6. The method of claim 1 further comprising the step of:
providing a remote server and storing the database on the remote server.

7. The method of claim 1 further comprising the step of:
updating the property information, the community information, and the priority information in the database.

8. The method of claim 1 further comprising the step of:
displaying the list of selected properties via the computer network.

9. The method of claim 1 wherein the plurality of properties are located on at least one of a plurality of islands.

10. A system for selecting one or more properties from a plurality of properties for a purchaser, the system comprising:
a computer network wherein the computer network has a database;
means for inputting property information, community information and priority information into the database wherein the property information, the community information and the priority information are stored in the database, wherein the property information is based on attributes of the plurality of properties, wherein the community information is based on attributes of a plurality of communities surrounding the plurality of properties wherein the community information is represented by primary criteria, secondary criteria, and tertiary criteria, and further wherein the priority information is based on priorities of the purchaser with respect to the attributes of the property information and the community information; and
means for executing a computer program wherein the computer program processes the primary criteria, the secondary criteria and/or the tertiary criteria wherein the computer program ranks the property information and further wherein the computer program selects the one or more properties from the plurality of properties based on the ranking of the property information.

11. The system of claim 10 wherein a first access to the database is provided to obtain identification of the one or more properties.

12. The system of claim 10 wherein the first access is remote with respect to the database.

13. The system of claim 10 including:
a remote server wherein the database is stored on the remote server.

14. The system of claim 10 wherein the database is updated via the computer network.

15. A method for selecting one or more properties from a plurality of islands for a purchaser, the method comprising the steps of:
providing a computer network wherein the computer network has a database;
providing property information wherein the property information is stored in the database and further wherein the property information is based on attributes of a plurality of properties on the plurality of islands;
providing community information wherein the community information is stored in the database and further wherein the community information is based on attributes of a plurality of communities on the plurality of islands surrounding the plurality of properties;
providing a first access to the database via the computer network wherein the purchaser inputs priority information into the database via the computer network wherein the priority information is stored in the database and further wherein the priority information is based on priorities of the purchaser with respect to the criteria of the property information and the community information; and
selecting the one or more properties located on the plurality of islands based on the property information, the community information and/or the priority information.

16. The method of claim 15 further comprising the step of:
updating the property information, the community information, and the priority information in the database via the computer network.

17. The method of claim 15 wherein the one or more properties selected are provided in a list.

18. The method of claim 15 further comprising the step of:
providing a second access to the database to retrieve identification of the one or more properties selected.

19. The method of claim 15 wherein the purchaser is provided identification of the one or more properties selected.

20. The method of claim 15 wherein the database is stored on a remote server.
